(19) United States
(12) Patent Application Publication
(10) Pub. No.: US 2012/0306391 A1
(43) Pub. Date: Dec. 6, 2012

(54) Modulized Full Operation Junction Ultra High Voltage (UHV) Device

(75) Inventors: Chang-Je Li, Taipei (TW); Mei-Chun Ko, Hsinchu City (TW); Erh-Jen Chu, Taipei (TW)

(73) Assignee: TAIWAN SEMICONDUCTOR MANUFACTURING COMPANY, LTD., Hsinchu (TW)

(21) Appl. No.: 13/153,087

(22) Filed: Jun. 3, 2011

(51) Int. Cl. H05B 37/02

(52) U.S. Cl. 315/192

(57) ABSTRACT

The present disclosure provides advantageous methods for controlling an ultra high voltage (UHV) light emitting diode (LED) device. In one embodiment, a method includes routing a first constant step current through a plurality of LED junction modules disposed over a substrate, each of the plurality of LED junction modules coupled in parallel to one another, and each of the plurality of LED junction modules including a plurality of LED junctions coupled in series. The method further includes reconfiguring a coupling scheme of the plurality of LED junction modules, and routing a second constant step current through the plurality of LED junction modules to provide a substantially same load to each LED junction.

### CROSS-REFERENCE TO RELATED APPLICATIONS

The present application is related to U.S. application Ser. No. 13/153,011 filed Jun. 3, 2011, (Attorney Docket No. TSMC 2011-0384/24061.1818), the entire disclosure of which is incorporated by reference herein for all purposes.

### BACKGROUND

Light emitting diode (LED) junctions have various applications in consumer electronics. Some LED junctions, for example, are used as light sources in space-limited applications and are increasingly being used in general lighting applications. LEDs may be optimized for display backlighting and illumination in automotive and transport, and consumer applications. Typical end-products include mobile telephone displays, flashes for cameras, retail and window displays, emergency lighting and signs, household appliances, automotive instrument panels and exterior lighting, such as brake lights and turn signals, and light bulbs.

It is desirable to improve the performance, reliability, and/or packaging of groups of LED junctions functioning together.

### SUMMARY

The present disclosure provides for many different embodiments. According to one embodiment, a method of controlling an ultra high voltage (UHV) light emitting diode (LED) device is provided. The method includes routing a first constant step current through a plurality of LED junction modules disposed over a substrate, each of the plurality of LED junction modules coupled in parallel to one another, and each of the plurality of LED junction modules including a plurality of LED junctions coupled in series. The method further includes reconfiguring a coupling scheme of the plurality of LED junction modules, and routing a second constant step current through the plurality of LED junction modules to provide a substantially same load to each LED junction.

In another embodiment, a method of controlling a UHV LED device includes providing B LED junction modules over a substrate, each of the B LED junction modules coupled in parallel to one another, and each of the B LED junction modules including A LED junctions coupled in series. The method further includes routing a first constant step current Bi through the B LED junction modules, and forming sets of (C₁A) LED junctions coupled in series and coupling in parallel sets of (B/C₂) LED junction modules coupled in series prior to routing a subsequent constant step current (B/C₁)i through each of the LED junctions. A, B, C₁, and C₂ are whole numbers; C₁ and C₂ are each whole number factors of B (C₁×C₂=B) and not equal to B; and i is a current routed through each LED junction.

In yet another embodiment, a method of controlling a UHV LED device includes providing a plurality of LED junction modules over a substrate, each of the plurality of LED junction modules coupled in parallel to one another, and each of the plurality of LED junction modules including a plurality of LED junctions coupled in series. The method further includes routing a first constant step current through the plurality of LED junction modules lighting each of the plurality of LED junction modules, reconfiguring a coupling scheme of the plurality of LED junction modules, and routing a second constant step current through the plurality of LED junction modules lighting each of the plurality of LED junction modules and providing a substantially same load to each LED junction with the first and second constant step currents.

### BRIEF DESCRIPTION OF THE DRAWINGS

Aspects of the present disclosure are understood from the following detailed description when read with the accompanying figures. It is emphasized that, in accordance with the standard practice in the industry, various features may not be drawn to scale. In fact, the dimensions of the various features may be arbitrarily increased or reduced for clarity of discussion.

FIGS. 1A-1C are flowcharts of methods of controlling an ultra high voltage (UHV) light emitting diode (LED) device in accordance with embodiments of the present disclosure.

FIG. 2 is an illustration of a UHV LED device in accordance with an embodiment of the present disclosure.

FIGS. 3A-1 through 3C-1 and 3A-2 through 3C-2 are illustrations and graphs of step currents and current density, respectively, routed through a UHV LED device in accordance with an embodiment of the present disclosure.

FIGS. 4A-4E are illustrations of step currents routed through a UHV LED device in accordance with another embodiment of the present disclosure.

FIGS. 5A-5B are illustrations of step currents routed through a UHV LED device in accordance with yet another embodiment of the present disclosure.

FIG. 6 is a flowchart of a method of controlling a UHV LED device in accordance with another embodiment of the present disclosure.

FIG. 7 is an illustration of a UHV LED device including a cross-sectional line C-C′ in accordance with an embodiment of the present disclosure.

FIG. 8 is a top view of an embodiment of an LED junction module in accordance with an embodiment of the present disclosure.

FIGS. 9A and 9B are embodiments of cross-sectional views of the device of FIG. 7 along line C-C′ in accordance with embodiments of the present disclosure.

FIGS. 10A-10C, 11, and 12 are cross-sectional views of a control component of the device of FIGS. 2 and 7 in accordance with embodiments of the present disclosure.

### DETAILED DESCRIPTION

It is understood that the following disclosure provides many different embodiments, or examples, for implementing different features of the disclosure. Specific examples of components and arrangements are described below to simplify the present disclosure. These are, of course, merely examples and are not intended to be limiting. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Various features may be arbitrarily drawn in different scales for the sake of simplicity and clarity. It is noted that the same or similar features may be similarly numbered herein for the sake of simplicity and clarity. In addition, some of the drawings may be simplified for clarity. Thus, the drawings may not depict all of the components of a given apparatus (e.g., device) or method.

Various aspects of the present disclosure will be described herein with reference to drawings that are schematic illustrations of idealized configurations of the present disclosure. As such, variations from the shapes of the illustrations as a result, for example, manufacturing techniques and/or tolerances, are to be expected. Thus, the various aspects of the present disclosure presented throughout this disclosure should not be construed as limited to the particular shapes of elements (e.g., regions, layers, sections, substrates, etc.) illustrated and described herein but are to include deviations in shapes that result, for example, from manufacturing. By way of example, an element illustrated or described as a rectangle may have rounded or curved features and/or a gradient concentration at its edges rather than a discrete change from one element to another. Thus, the elements illustrated in the drawings are schematic in nature and their shapes are not intended to illustrate the precise shape of an element and are not intended to limit the scope of the present disclosure.

It will be understood that when an element such as a region, layer, section, substrate, or the like, is referred to as being “on” another element, it can be directly on the other element or intervening elements may also be present. In contrast, when an element is referred to as being “directly on” another element, there are no intervening elements present. It will be further understood that when an element is referred to as being “formed” on another element, it can be grown, deposited, etched, attached, connected, coupled, or otherwise prepared or fabricated on the other element or an intervening element.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items

It will be understood that although the terms “first”, “second”, “third”, and so on, may be used herein to describe various LED junctions, LED junction modules, and/or step currents, the LED junctions, LED junction modules, and/or step currents should not be limited by these terms. These terms are only used to distinguish one LED junction, LED junction module, or step current from another LED junction, LED junction module, or step current. Thus, a first LED junction, first half of a plurality of LED junction modules, or first step current discussed below could be termed a second LED junction, a second half of a plurality of LED junction modules, or a second step current without departing from the teachings of the present disclosure.

It is understood that several processing steps and/or features of a device may be only briefly described, such steps and/or features being well known to those of ordinary skill in the art. Also, additional processing steps or features can be added, and certain of the following processing steps or features can be removed and/or changed while still implementing the claims. Thus, the following description should be understood to represent examples only, and are not intended to suggest that one or more steps or features is required.

UHV LED emitters have been used for lighting applications. LEDs and LED displays may suffer from varying illumination levels as a result of changes in or varying power supply voltages. To keep LED brightness substantially constant or with higher uniformity, different supply currents may be applied. UHV LED emitters may include LED junctions coupled in series, and as multiple currents are applied to the UHV LED emitter, different numbers of LED junctions may be activated or lit for each step. The total die area and power consumption of UHV LED emitters may not be optimized or efficient, and LED junctions may experience uneven loading over time. Thus, UHV LED emitters may not be efficiently sized and performance and reliability issues may arise with uneven load on the LED junctions. Furthermore, it is desirable to efficiently package a UHV LED emitter's passive component and control component.

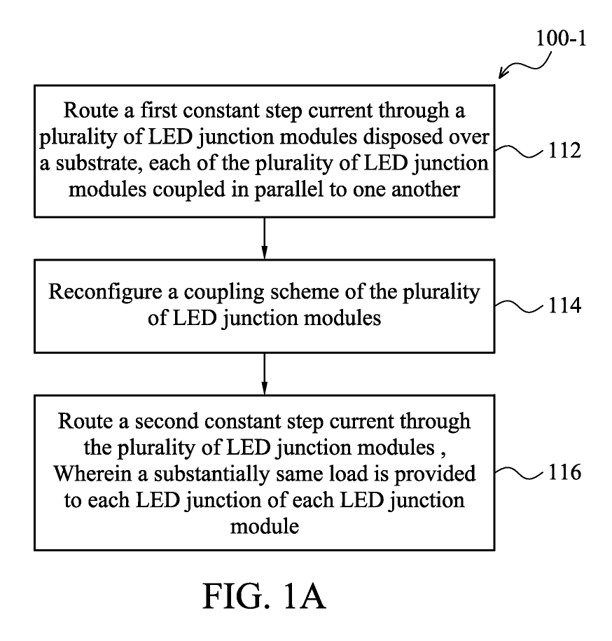

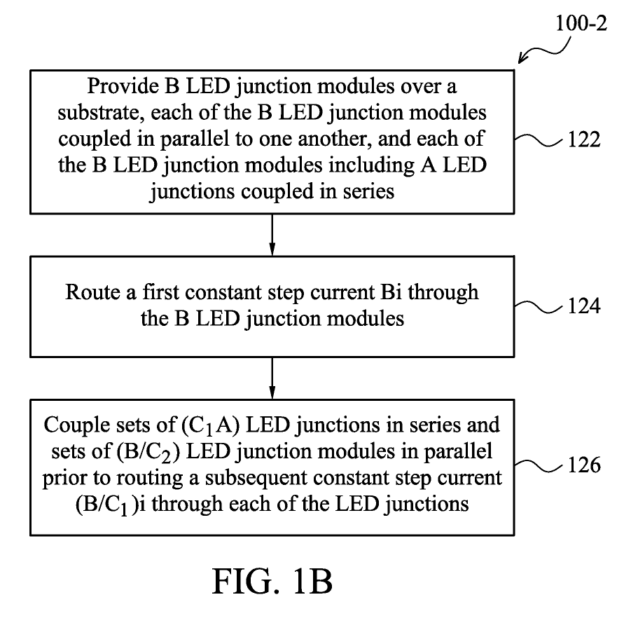

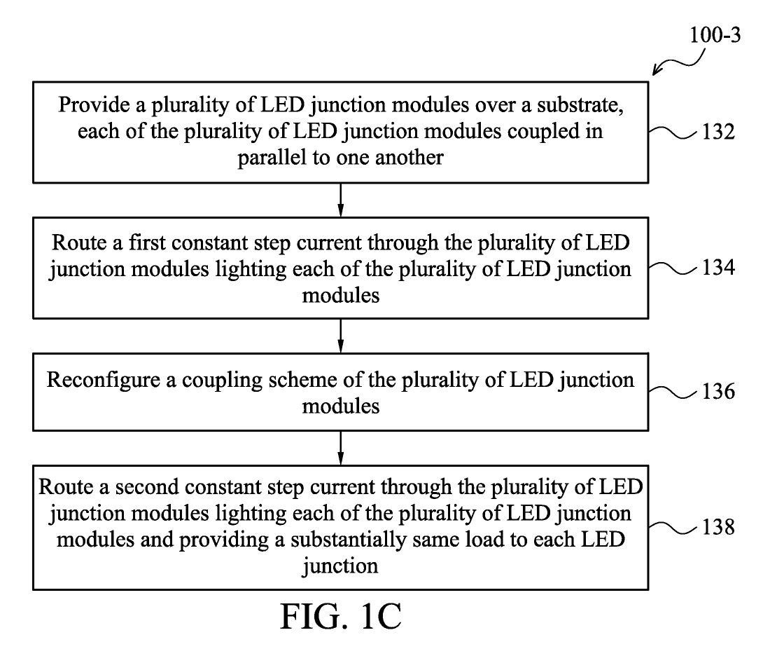

Referring now to FIGS. 1A, 1B, and 1C, flowcharts are shown illustrating methods 100-1, 100-2, and 100-3, respectively, for controlling an ultra high voltage (UHV) light emitting diode (LED) device in accordance with embodiments of the present disclosure.

Method 100-1 comprises, at block 112, routing a first constant step current through a plurality of LED junction modules disposed over a substrate, each of the plurality of LED junction modules coupled in parallel to one another, and each of the plurality of LED junction modules including a plurality of LED junctions coupled in series. Method 100-1 further includes, at block 114, reconfiguring a coupling scheme of the plurality of LED junction modules to provide a substantially same load to each LED junction. Method 100-1 further includes, at block 116, routing a second constant step current through the plurality of LED junction modules.

Method 100-2 comprises, at block 122, providing B LED junction modules over a substrate, each of the B LED junction modules coupled in parallel to one another, and each of the B LED junction modules including A LED junctions coupled in series. Method 100-2 further includes, at block 124, routing a first constant step current Bi through the B LED junction modules. Method 100-2 further includes, at block 126, forming sets of (C₁A) LED junctions coupled in series and coupling in parallel sets of (B/C₂) LED junction modules coupled in series prior to routing a subsequent constant step current (B/C₁)i through each of the LED junctions. According to one aspect, A, B, C₁, and C₂ are whole numbers; C₁ and C₂ are each whole number factors of B (C₁×C₂=B) and not equal to B; and i is a current routed through each LED junction.

Method 100-3 comprises, at block 132, providing a plurality of LED junction modules over a substrate, each of the plurality of LED junction modules coupled in parallel to one another, and each of the plurality of LED junction modules including a plurality of LED junctions coupled in series. Method 100-3 further includes, at block 134, routing a first constant step current through the plurality of LED junction modules lighting each of the plurality of LED junction modules. Method 100-3 further includes, at block 136, reconfiguring a coupling scheme of the plurality of LED junction modules, and at block 138, routing a second constant step current through the plurality of LED junction modules lighting each of the plurality of LED junction modules and providing a substantially same load to each LED junction with the first and second constant step currents.

The various structures in methods 100-1, 100-2, and 100-3 described above may be formed by various techniques, such as deposition, pattern, and/or etch techniques. It should be noted that the operations of methods 100-1, 100-2, or 100-3 may be rearranged or otherwise modified within the scope of the various aspects. It is further noted that additional processes may be provided before, during, and after each of the methods 100-1, 100-2, or 100-3, and that some other processes may only be briefly described herein. Thus, other implementations are possible within the scope of the various aspects described herein.

According to one aspect of the methods described above, reconfiguring the coupling scheme of the plurality of LED junction modules may include coupling in series a first half of the plurality of LED junction modules with a second half of the plurality of LED junction modules prior to routing a constant step current.

According to another aspect of the methods described above, reconfiguring the coupling scheme of the plurality of LED junction modules may include coupling in series a fraction of the plurality of LED junction modules with one another prior to routing a constant step current.

According to another aspect of the methods described above, reconfiguring the coupling scheme of the plurality of LED junction modules may include coupling in series a half, a third, a fourth, a fifth, or a sixth of the plurality of LED junction modules with one another prior to routing a constant step current.

According to another aspect of the methods described above, the plurality of LED junction modules may include B LED junction modules coupled in parallel and each LED junction module may include A LED junctions coupled in series. The method may then further include: routing a first constant step current Bi through the plurality of LED junction modules; forming sets of 2A LED junctions coupled in series and coupling in parallel sets of (B/3) LED junction modules coupled in series prior to routing a second constant step current (B/2)i through the plurality of LED junction modules; and forming sets of 3A LED junctions coupled in series and coupling in parallel sets of (B/2) LED junction modules coupled in series prior to routing a third constant step current (B/3)i through the plurality of LED junction modules, wherein A and B are whole numbers, and i is a current routed through each LED junction (see, e.g., FIGS. 3A-1 through 3C-1).

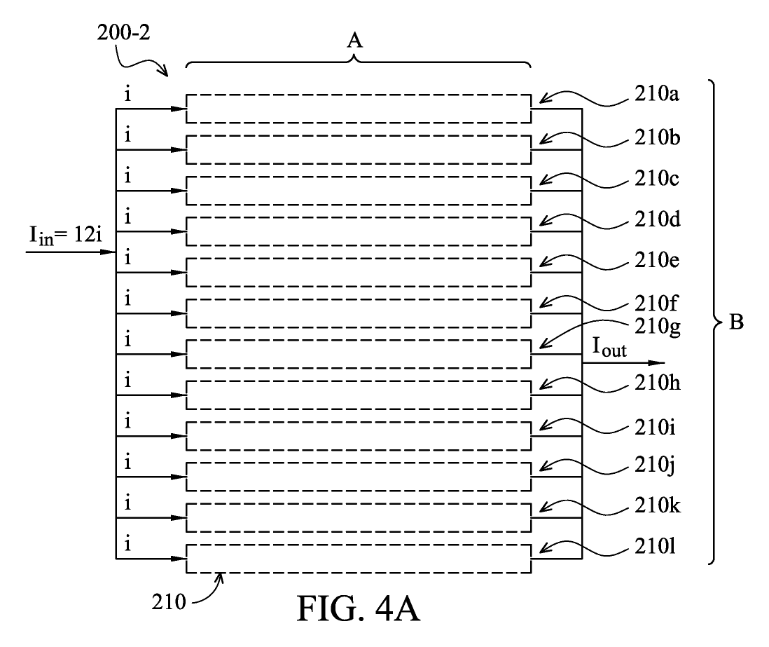

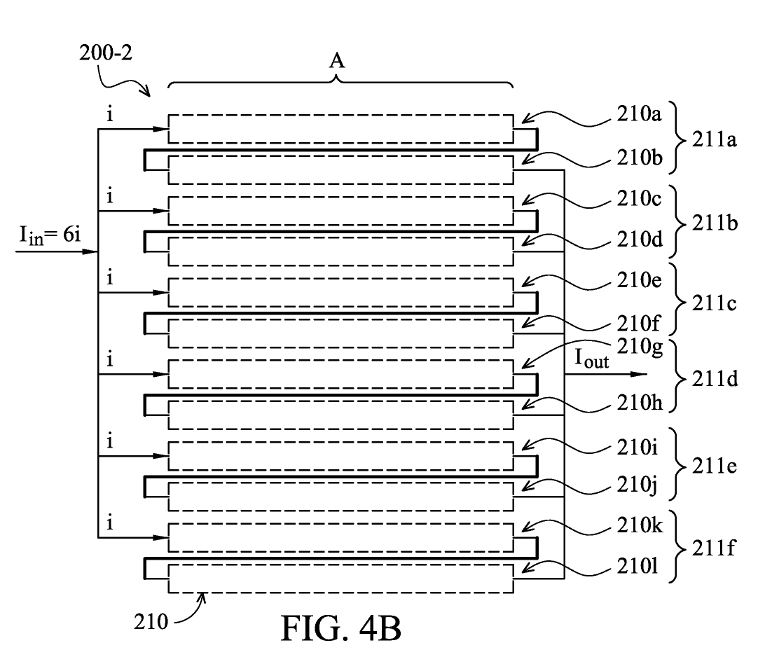

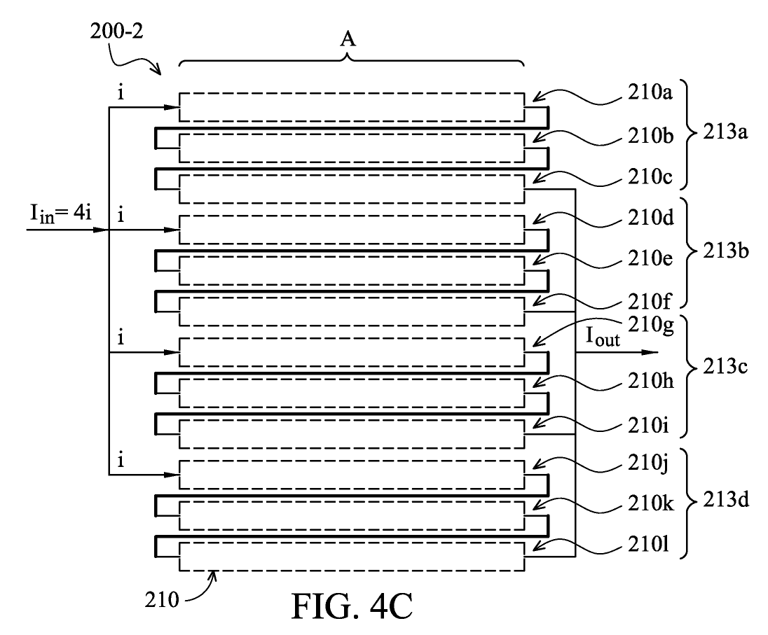

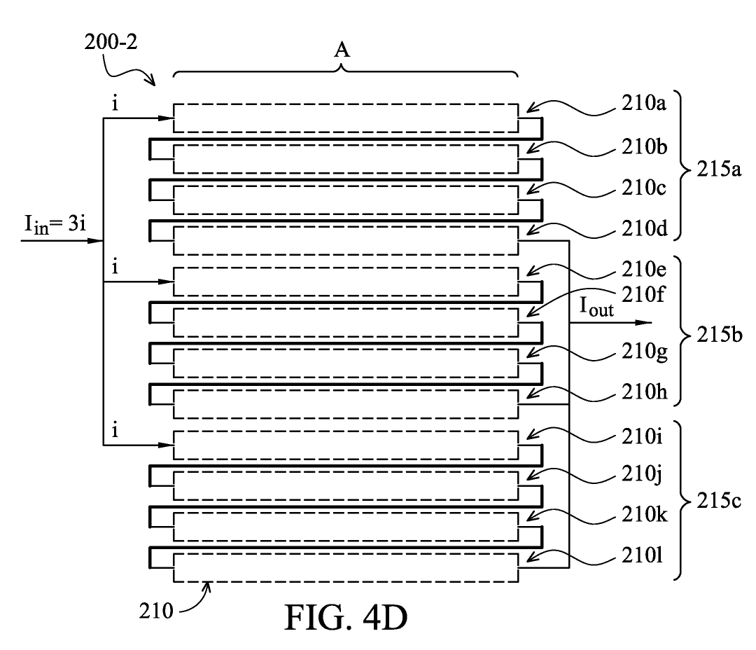

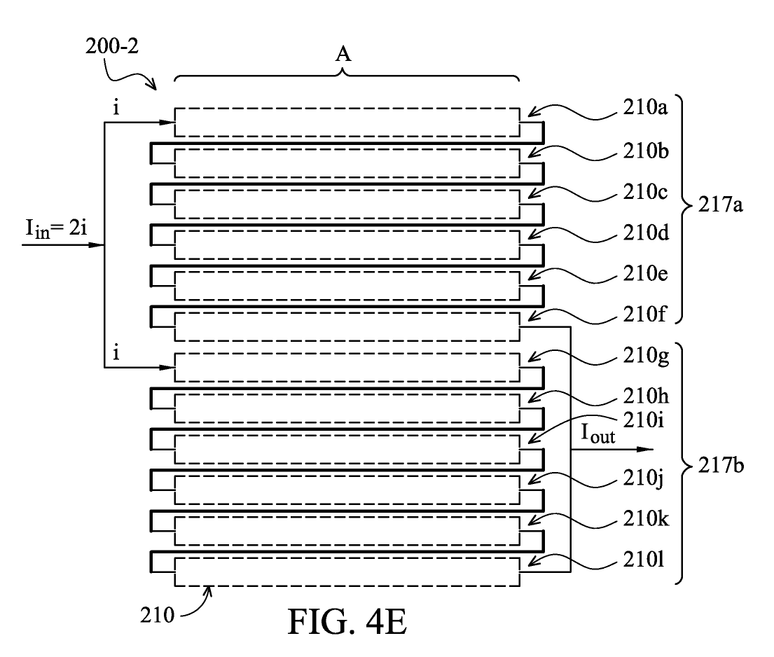

According to another aspect of the methods described above, the plurality of LED junction modules may include B LED junction modules coupled in parallel and each LED junction module may include A LED junctions coupled in series. The method may then further include: routing a first constant step current Bi through the plurality of LED junction modules; forming sets of 2A LED junctions coupled in series and coupling in parallel sets of (B/6) LED junction modules coupled in series prior to routing a second constant step current (B/2)i through the plurality of LED junction modules; forming sets of 3A LED junctions coupled in series and coupling in parallel sets of (B/4) LED junction modules coupled in series prior to routing a third constant step current (B/3)i through the plurality of LED junction modules; forming sets of 4A LED junctions coupled in series and coupling in parallel sets of (B/3) LED junction modules coupled in series prior to routing a fourth constant step current (B/4)i through the plurality of LED junction modules; and forming sets of 6A LED junctions coupled in series and coupling in parallel sets of (B/2) LED junction modules coupled in series prior to routing a fifth constant step current (B/6)i through the plurality of LED junction modules, wherein A and B are whole numbers, and i is a current routed through each LED junction (see, e.g., FIGS. 4A-4E).

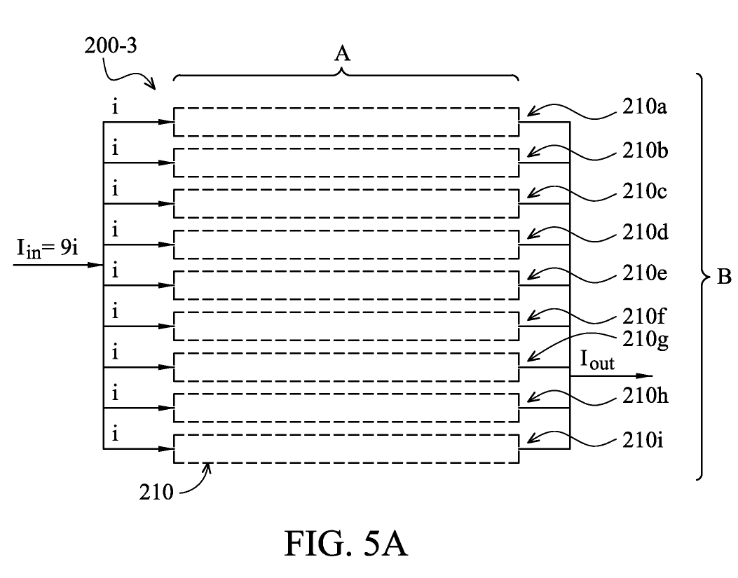

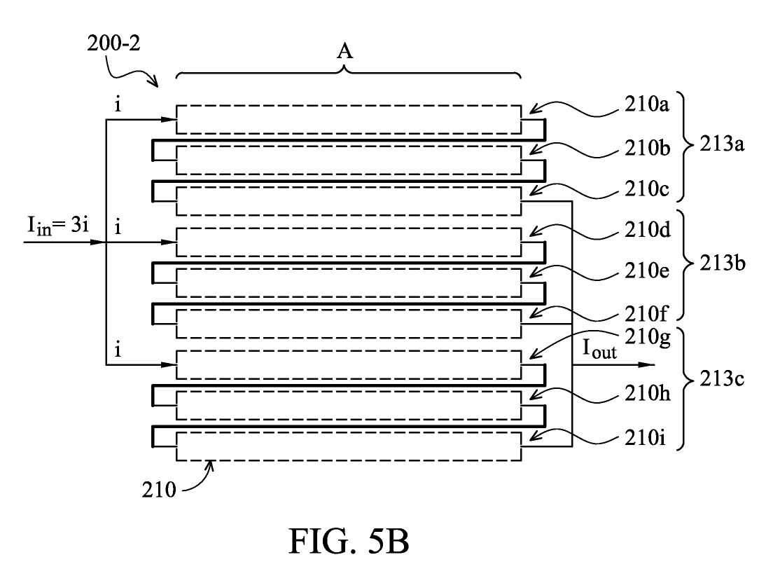

According to another aspect of the methods described above, the plurality of LED junction modules may include B LED junction modules coupled in parallel and each LED junction module may include A LED junctions coupled in series. The method may then further include: routing a first constant step current Bi through the plurality of LED junction modules; and forming sets of 3A LED junctions coupled in series and coupling in parallel sets of (B/3) LED junction modules coupled in series prior to routing a second constant step current (B/3)i through the plurality of LED junction modules, wherein A and B are whole numbers, and i is a current routed through each LED junction (see, e.g., FIGS. 5A and 5B).

According to another aspect of the methods described above, each of the plurality of LED junctions may be activated with each constant step current.

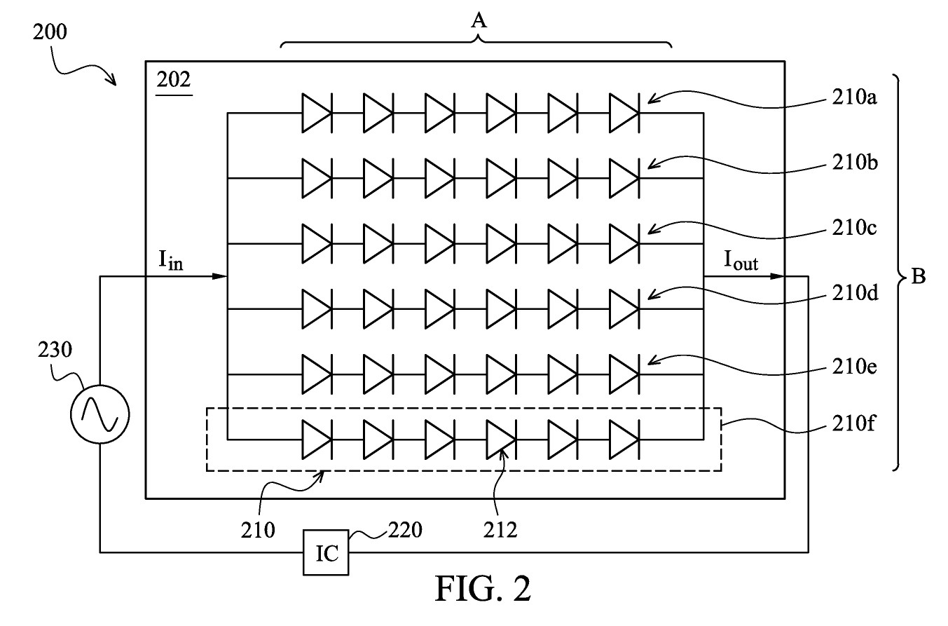

Referring now to FIG. 2, a UHV LED device 200 is illustrated in accordance with an embodiment of the present disclosure. UHV LED device 200 includes a substrate 202, a plurality of LED junction modules 210 disposed over the substrate 202 and first coupled in parallel to one another (i.e., each of the LED junction modules 210 are first coupled in parallel with one another). Each of the plurality of LED junction modules 210 includes a plurality of LED junctions 212 coupled in series.

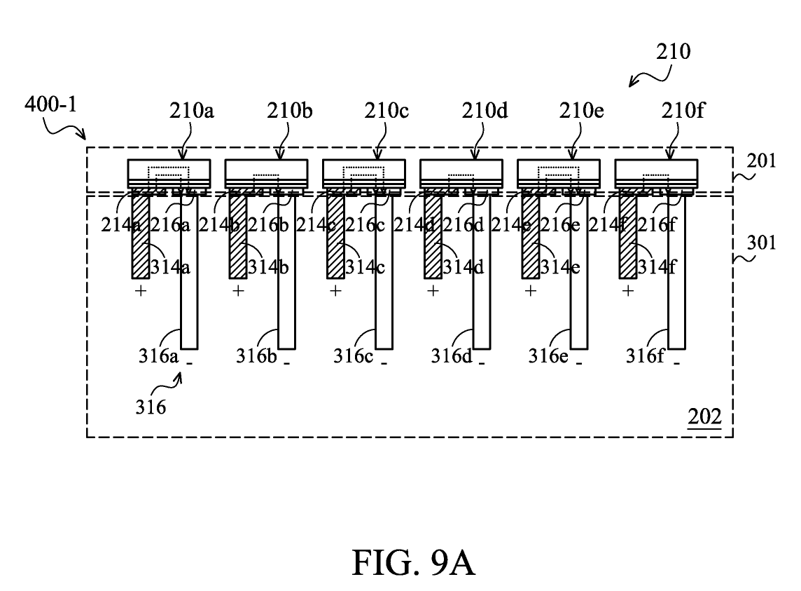

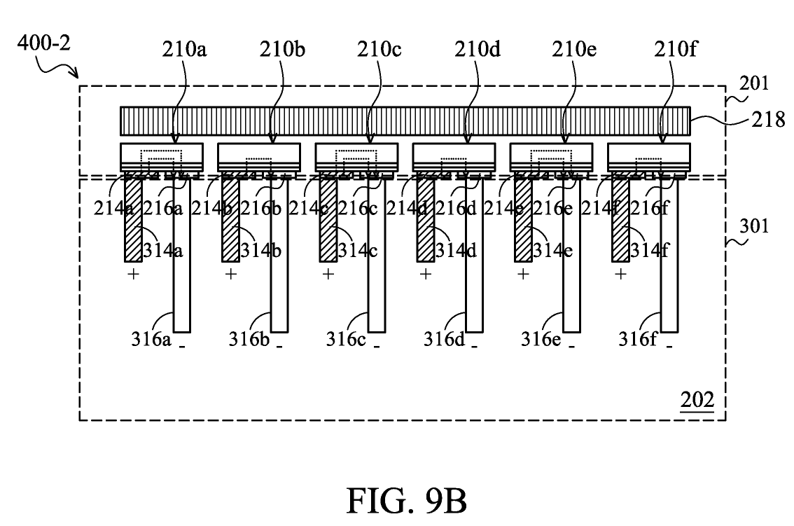

Device 200 further includes an integrated circuit (IC) 220 coupled to the plurality of LED junction modules 210. In one aspect, IC 220 is configured to control electrical connections between LED junction modules 210 or a control component of device 200. An example of a control component is illustrated in FIGS. 9A-12 and further described below with respect to the relevant figures. In one example, IC 220 can dynamically reconfigure electrical connections (e.g., switches) between the plurality of LED junction modules 210 at each of a plurality of constant step currents received by the plurality of LED junction modules 210 to provide a substantially same load to each LED junction 212 during each of the plurality of constant step currents. The plurality of constant step currents are provided by a power source 230 operably coupled to the plurality of LED junction modules 210 and IC 220.

Device 200 is shown including B LED junction modules 210 (e.g., modules 210a through 210z) coupled in parallel to one another, and each LED junction module 210 includes A LED junctions 212 coupled in series to one another. The total number of LED junctions is then A×B, and the B LED junction modules are coupled in parallel prior to provision of a first constant step current. A and B are any whole numbers and thus device 200 is not limited to a particular number of LED junction modules 210 or a particular number of LED junctions 212 within each module 210.

According to one embodiment of operating device 200, a first constant step current Bi is routed through the B LED junction modules. Sets of (C₁A) LED junctions 212 coupled in series are formed and sets of (B/C₂) LED junction modules coupled in series are coupled in parallel prior to routing a subsequent constant step current (B/C₁)i through each of the LED junctions 212, wherein A, B, C₁, and C₂ are whole numbers; C₁ and C₂ are each whole number factors of B (C₁×C₂=B) and not equal to B; and i is a current routed through each LED junction 212. In accordance with yet another aspect, each of the plurality of LED junctions 212 are active (or lit) during each of the plurality of constant step currents.

In accordance with one aspect, substrate 202 may include various semiconductor devices, and/or other suitable active and/or passive devices. Example semiconductor devices include integrated circuits including a metal-insulator-semiconductor field effect transistor (MOSFET) including complementary MOSFET (CMOS) features, CIS, and/or other suitable active and/or passive devices. In an embodiment, the substrate may include an integrated circuit (or portion thereof) designed and formed using a CMOS-based process. A substrate having a device (e.g., integrated circuit) formed by other semiconductor fabrication technologies is also within the scope of the described method.

In one embodiment, substrate 202 may include a semiconductor substrate, and may be comprised of silicon, or alternatively may include silicon germanium, gallium arsenic, or other suitable semiconductor materials. The semiconductor substrate may include underlying layers, devices, junctions, and other features (not shown) formed during prior process steps or which may be formed during subsequent process steps.

In accordance with one aspect, IC 220 may reconfigure a coupling scheme of the plurality of LED junction modules 210 to provide a substantially same load to each LED junction 212 or to route a substantially same current to each LED junction 212 during a plurality of constant step currents. In accordance with another aspect, IC 220 may form sets of (C₁A) LED junctions 212 coupled in series and couple in parallel sets of (B/C₂) LED junction modules coupled in series prior to routing a constant step current (B/C₁)i through each of the LED junctions 212, wherein A, B, C₁, and C₂ are whole numbers; C₁ and C₂ are each whole number factors of B (C₁×C₂=B) and not equal to B; and i is a current routed through each LED junction 212.

In accordance with another aspect, IC 220 may configure a half of the plurality of LED junction modules 210 to be in series with the other half of the plurality of LED junction modules 210 prior to provision of a constant step current. In accordance with another aspect, IC 220 may configure half of the plurality of LED junction modules to be in series with one another prior to provision of a constant step current. In accordance with another aspect, IC 220 may couple in series a fraction of the plurality of LED junction modules with one another prior to routing a constant step current, and according to another aspect IC 220 may reconfigure the coupling scheme of the plurality of LED junction modules to couple in series a half, a third, a fourth, a fifth, or a sixth of the plurality of LED junction modules with one another prior to routing a constant step current.

In accordance with yet another aspect, IC 220 may dynamically reconfigure electrical connections between the plurality of LED junction modules 210 at each constant step current to provide a substantially same load to each LED junction 212 of each LED junction module 210 during each constant step current. In accordance with yet another aspect, IC 220 may be disposed over the substrate 202, within the substrate 202, and/or on a separate printed circuit board (PCB). In one example, PCB may be exterior to substrate 202.

In accordance with one aspect, power source 230 provides stepping DC power in one example, but may include any of various power supplies for providing current and/or voltage, and in particular a plurality of constant step currents. In one example, power source 230 may convert AC power to stepping DC power. In another example, power source 230 may further include a power supply regulator and/or a diode bridge. Power source 230 is configured to provide the plurality of constant step currents to the plurality of LED junction modules 210, and in one example may provide the first constant step current denoted by Bi, and a second constant step current denoted by (B/C₁)i, wherein B and C₁ are whole numbers; C₁ is a whole number factor of B and not equal to B; and i is a current routed through each LED junction 212.

Referring now to FIGS. 3A-1 through 3C-2, 4A-4E, and 5A-5B, different example LED junction module coupling schemes and step currents routed through UHV LED devices 200-1, 200-2, and 200-3, respectively, are shown in accordance with embodiments of the present disclosure. UHV LED device 200-1 in FIGS. 3A-1 through 3C-1 includes six LED junction modules 210a-210f first coupled in parallel, and each LED junction module 210 includes six LED junctions 212. UHV LED device 200-2 in FIGS. 4A-4E includes twelve LED junction modules 210a-210l first coupled in parallel, and each LED junction module 210 includes A LED junctions 212. UHV LED device 200-3 in FIGS. 5A-5B includes nine LED junction modules 210a-210i first coupled in parallel, and each LED junction module 210 includes A LED junctions 212.

Referring in particular to FIGS. 3A-1 through 3C-1 and 3A-2 through 3C-2, illustrations and graphs are shown of step currents following a coupling scheme and current density, respectively, routed through UHV LED device 200-1 in accordance with an embodiment of the present disclosure.

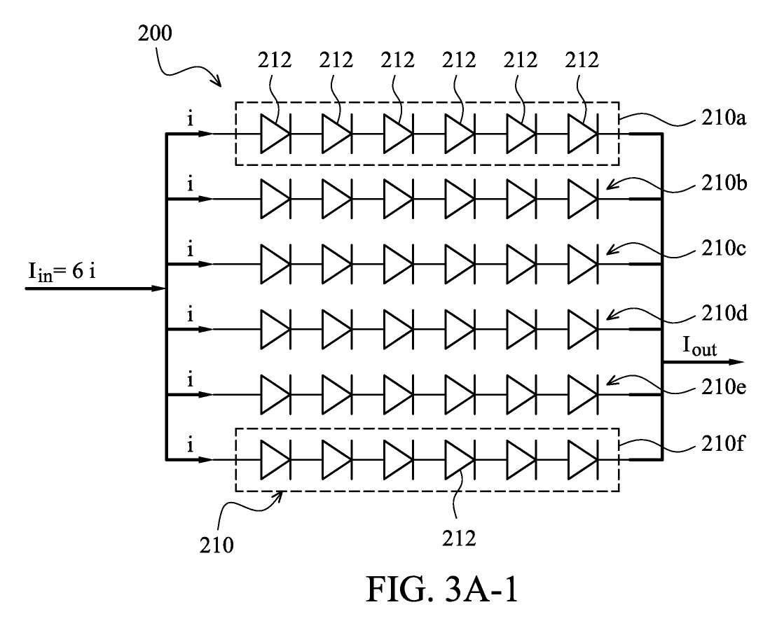

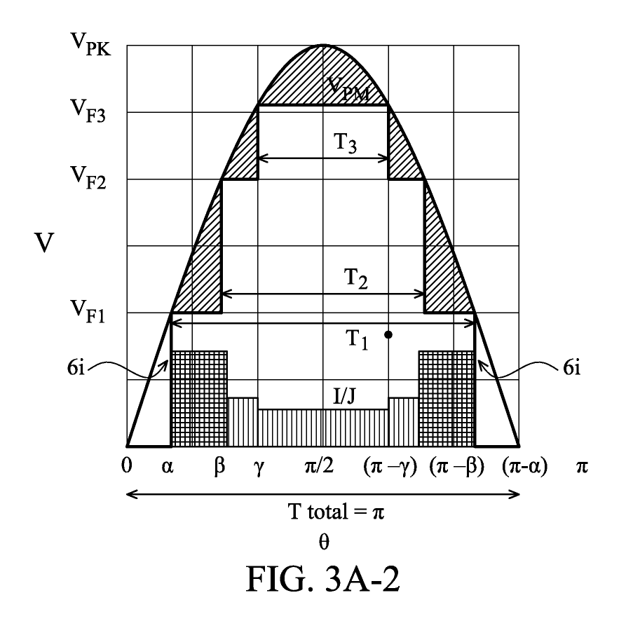

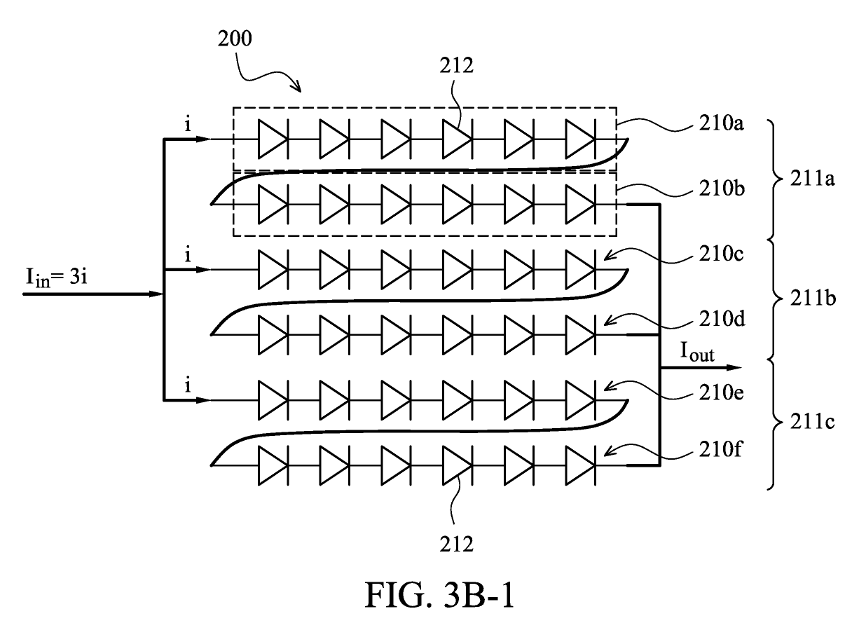

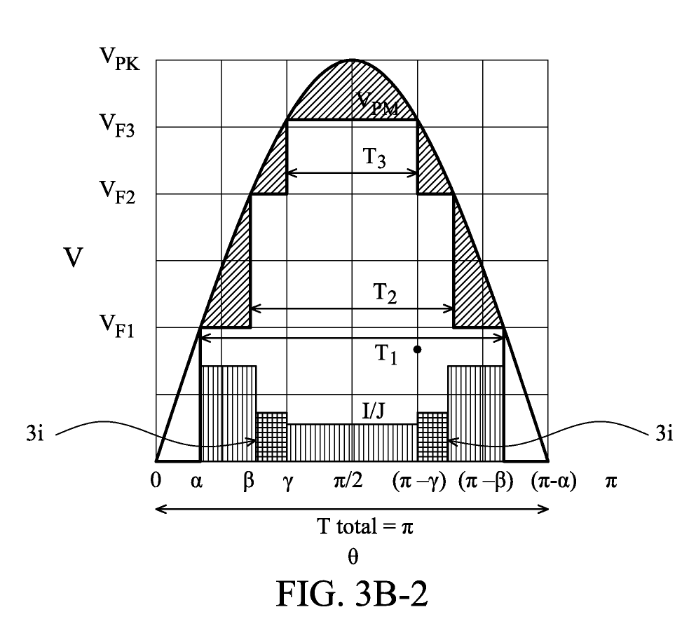

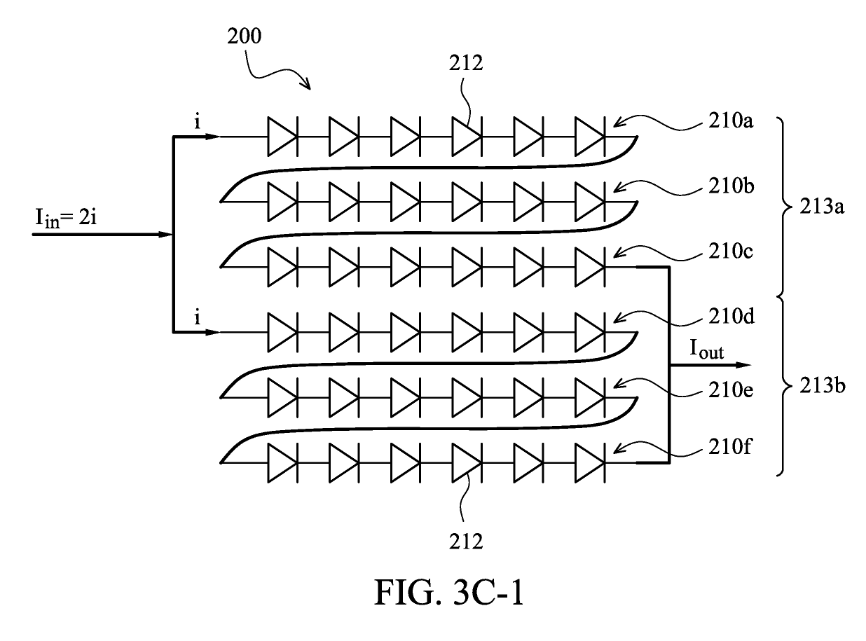

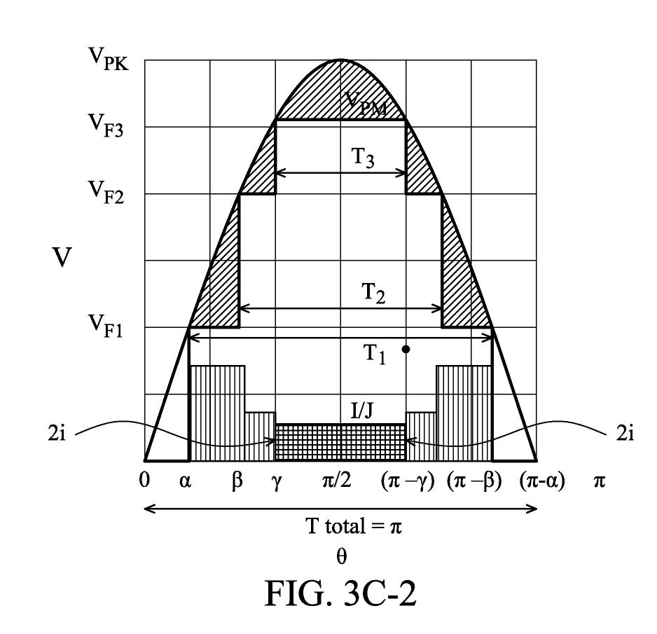

FIG. 3A-1 illustrates device 200-1 including a plurality of 6 LED junction modules 210a-210f first coupled in parallel, with each LED junction module 210 including 6 LED junctions 212. LED junction modules 210a-210f are coupled in parallel prior to provision of a first constant step current 6i, which is split into input currents i applied to each LED junction module 210.

FIG. 3A-2 shows a graph of a first current density with a first constant step current 6i over a time cycle of π. V_{(F1, F2, . . . FN)}/V_{PK} determines conduction angle of each step, where V_{(FN)} is a step voltage, N is a real number, and V_{PK} is peak voltage. α=sin⁻¹ (VF₁/V_{PK}), β=sin⁻¹ (VF₂/V_{PK}), etc. I=I(θ) when α<θ<(π−α) or 0 if not. Pᵢₙ={∫[V_{In}(θ)*I(θ)]dθ}, θ from α to (π−α). P_{led}={∫[V_{(FN)}*I(θ)]dθ}, θ from α to (π−α). PE=P_{led}/Pᵢₙ.

FIG. 3B-1 illustrates the formation of 3 sets of 12 LED junctions 212 coupled in series and the coupling in parallel of 3 sets of 2 LED junction modules 210 coupled in series prior to provision of a second constant step current 3i. In this embodiment, modules 210a and 210b are coupled in series to form a LED junction module 211a, modules 210c and 210d are coupled in series to form a LED junction module 211b, and modules 210e and 210f are coupled in series to form a LED junction module 211c. Thus, sets of 12 LED junctions 212 coupled in series are formed and 3 LED junction modules 211a, 211b, 211c are coupled in parallel prior to provision of a second constant step current 3i, which is split into input currents i applied to each LED junction module 211a, 211b, 211c and each LED junction 212. FIG. 3B-2 shows a graph of a second current density with a second constant step current (B/2)i over a time cycle of π.

FIG. 3C-1 illustrates the formation of 2 sets of 18 LED junctions 212 coupled in series and the coupling in parallel of 2 sets of 3 LED junction modules 210 coupled in series prior to provision of a third constant step current 2i. In this embodiment, modules 210a, 210b, 210c are coupled in series to form a LED junction module 213a, and modules 210d, 210e, 210f are coupled in series to form a LED junction module 213b. Thus, sets of 18 LED junctions 212 coupled in series are formed and 2 LED junction modules 213a, 213b are coupled in parallel prior to provision of third constant step current 2i, which is split into input currents i applied to each LED junction module 213a, 213b and each LED junction 212. FIG. 3C-2 shows a graph of a third current density with a third constant step current (B/3)i over a time cycle of π.

Thus, in this embodiment, A=6, B=6, C₁=2 or 3, and C₂=3 or 2 when controlling device 200-1 in accordance with forming sets of (C₁A) LED junctions coupled in series, and coupling in parallel sets of (B/C₂) LED junction modules coupled in series prior to routing a subsequent constant step current (B/C₁)i through the plurality of LED junction modules, wherein A, B, C₁, and C₂ are whole numbers, wherein C₁ and C₂ are each whole number factors of B and not equal to B, and wherein i is a current routed through each LED junction.

Referring in particular to FIGS. 4A-4E, illustrations are shown of step currents following a coupling scheme routed through UHV LED device 200-2 in accordance with an embodiment of the present disclosure.

FIG. 4A illustrates device 200-2 including a plurality of 12 LED junction modules 210a-210l first coupled in parallel, with each LED junction module 210 including A=6 LED junctions 212. LED junction modules 210a-210l are coupled in parallel prior to provision of a first constant step current 12i, which is split into input currents i applied to each LED junction module 210.

FIG. 4B illustrates the formation of 6 sets of 12 LED junctions 212 coupled in series and the coupling in parallel of 6 sets of 2 LED junction modules 210 coupled in series prior to provision of a second constant step current 6i. In this embodiment, modules 210a and 210b are coupled in series to form a LED junction module 211a, modules 210c and 210d are coupled in series to form a LED junction module 211b, modules 210e and 210f are coupled in series to form a LED junction module 211c, modules 210g and 210h are coupled in series to form a LED junction module 211d, modules 210i and 210j are coupled in series to form a LED junction module 211e, and modules 210k and 210l are coupled in series to form a LED junction module 211f. Thus, sets of 12 LED junctions 212 coupled in series are formed and sets of 6 LED junction modules 211a-211f are coupled in parallel prior to provision of a second constant step current 6i, which is split into input currents i applied to each LED junction module 211a-211f and each LED junction 212.

FIG. 4C illustrates the formation of 4 sets of 18 LED junctions 212 coupled in series and the coupling in parallel of 4 sets of 3 LED junction modules 210 coupled in series prior to provision of a third constant step current 4i. In this embodiment, modules 210a, 210b, 210c are coupled in series to form a LED junction module 213a, modules 210d, 210e, 210f are coupled in series to form a LED junction module 213b, modules 210g, 210h, 210i are coupled in series to form a LED junction module 213c, and modules 210j, 210k, 210l are coupled in series to form a LED junction module 213d. Thus, sets of 18 LED junctions 212 coupled in series are formed and 4 LED junction modules 213a-213d are coupled in parallel prior to provision of third constant step current 4i, which is split into input currents i applied to each LED junction module 213a-213d and each LED junction 212.

FIG. 4D illustrates the formation of 3 sets of 24 LED junctions 212 coupled in series and the coupling in parallel of 3 sets of 4 LED junction modules 210 coupled in series prior to provision of a fourth constant step current 3i. In this embodiment, modules 210a, 210b, 210c, 210d are coupled in series to form a LED junction module 215a, modules 210e, 210f, 210g, 210h are coupled in series to form a LED junction module 215b, and modules 210i, 210j, 210k, 210l are coupled in series to form a LED junction module 215c. Thus, sets of 24 LED junctions 212 coupled in series are formed and 3 LED junction modules 215a-215c are coupled in parallel prior to provision of fourth constant step current 3i, which is split into input currents i applied to each LED junction module 215a-215c and each LED junction 212.

FIG. 4E illustrates the formation of 2 sets of 36 LED junctions 212 coupled in series and the coupling in parallel of 2 sets of 6 LED junction modules 210 coupled in series prior to provision of a fifth constant step current 2i. In this embodiment, modules 210a, 210b, 210c, 210d, 210e, 210f are coupled in series to form a LED junction module 217a, and modules 210g, 210h, 210i, 210j, 210k, 210l are coupled in series to form a LED junction module 217b. Thus, sets of 36 LED junctions 212 coupled in series are formed and 2 LED junction modules 217a, 217b are coupled in parallel prior to provision of fifth constant step current 2i, which is split into input currents i applied to each LED junction module 217a, 217b and each LED junction 212.

Thus, in this embodiment, A=6, B=12, C₁=2, 3, 4, or 6 and C₂=2, 3, 4, or 6 when controlling device 200-2 in accordance with forming sets of (C₁A) LED junctions coupled in series, and coupling in parallel sets of (B/C₂) LED junction modules coupled in series prior to routing a subsequent constant step current (B/C₁)i through the plurality of LED junction modules, wherein A, B, C₁, and C₂ are whole numbers, wherein C₁ and C₂ are each whole number factors of B (C₁×C₂=B) and not equal to B, and wherein i is a current routed through each LED junction.

Referring in particular to FIGS. 5A and 5B, illustrations are shown of step currents following a coupling scheme routed through UHV LED device 200-3 in accordance with an embodiment of the present disclosure.

FIG. 5A illustrates device 200-3 including a plurality of 9 LED junction modules 210a-210i first coupled in parallel, with each LED junction module 210 including A=6 LED junctions 212. LED junction modules 210a-210i are coupled in parallel prior to provision of a first constant step current 9i, which is split into input currents i applied to each LED junction module 210.

FIG. 5B illustrates the formation of 3 sets of 18 LED junctions 212 coupled in series and the coupling in parallel of 3 sets of 3 LED junction modules 210 coupled in series prior to provision of a second constant step current 3i. In this embodiment, modules 210a, 210b, 210c are coupled in series to form a LED junction module 213a, modules 210d, 210e, 210f are coupled in series to form a LED junction module 213b, and modules 210g, 210h, 210i are coupled in series to form a LED junction module 213c. Thus, sets of 18 LED junctions 212 coupled in series are formed and 3 LED junction modules 213a-213c are coupled in parallel prior to provision of second constant step current 3i, which is split into input currents i applied to each LED junction module 213a-213c and each LED junction 212.

Thus, in this embodiment, A=6, B=9, C₁=3 and C₂=3 when controlling device 200-3 in accordance with forming sets of (C₁A) LED junctions coupled in series, and coupling in parallel sets of (B/C₂) LED junction modules coupled in series prior to routing a subsequent constant step current (B/C₁)i through the plurality of LED junction modules, wherein A, B, C₁, and C₂ are whole numbers, wherein C₁ and C₂ are each whole number factors of B (C₁×C₂=B) and not equal to B, and wherein i is a current routed through each LED junction.

Thus, in one embodiment, IC 220 may dynamically reconfigure electrical connections between the plurality of LED junction modules 210 at each of a plurality of constant step currents received by the plurality of LED junction modules 210 to provide a substantially same load to each LED junction 212 during each of the plurality of constant step currents (e.g., as shown in FIGS. 3A-1, 3B-1, 3C-1). In accordance with one aspect, IC 220 may configure a first half of the plurality of LED junction modules 210 (e.g., modules 210a, 210c, 210e of FIG. 3B-1) to be in series with the other half or a second half of the plurality of LED junction modules 210 (e.g., modules 210b, 210d, 210f of FIG. 3B-1) prior to provision of a constant step current. In accordance with another aspect, IC 220 may configure half of the plurality of LED junction modules (e.g., modules 210a, 210b, 210c or modules 210d, 210e, 210f of FIG. 3C-1) to be in series with one another prior to provision of a constant step current. In accordance with another aspect, each of the plurality of LED junctions 212 are active or lit during each of the plurality of constant step currents.

Advantageously, the present disclosure provides for efficient total die area utilization and power consumption while also improving performance and reliability with even or constant loading of the plurality of LED junctions over time.

The methods described above and/or the reconfiguration of coupling schemes of the LED junction modules may be accomplished by various means and procedures. For example, the coupling scheme of the plurality of LED junction modules may be dynamically configured and/or changed by various switches or multiplexers controlled by an IC. These switches, multiplexers, and/or IC may be disposed over the substrate 202, within the substrate 202, and/or on a separate printed circuit board (PCB). In one example, PCB may be exterior to substrate 202. Examples of applicable switches include but are not limited to 2-way switches, 3-way switches, transistors, and MEMS transistors. A control component of a UHV LED device will be further described below with respect to FIGS. 9A-12.

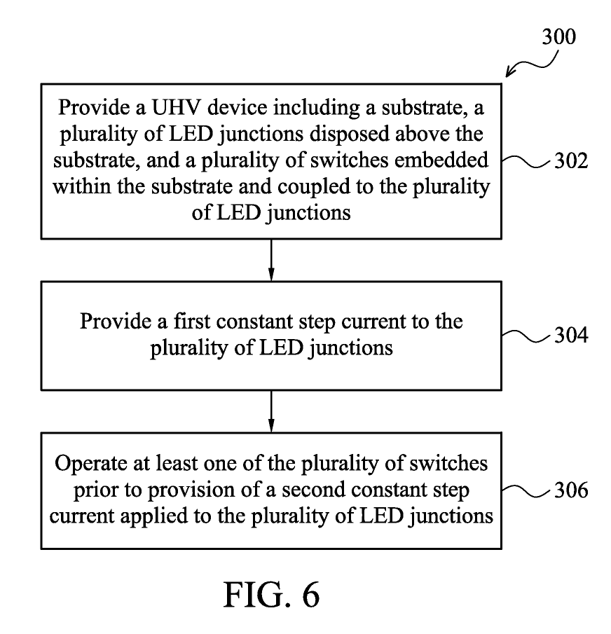

Referring now to FIG. 6, a flowchart is illustrated of a method 300 of controlling an ultra high voltage (UHV) light emitting diode (LED) device in accordance with another embodiment of the present disclosure. Method 300 comprises, at block 302, providing a UHV LED device including a substrate, a passive component including a plurality of LED junctions disposed above the substrate and coupled to one another, and a control component including a plurality of switches embedded within the substrate and coupled to the plurality of LED junctions to control a plurality of step currents applied to the plurality of LED junctions.

Method 300 further includes, at block 304, providing a first constant step current to the plurality of LED junctions, and at block 306, operating (e.g., opening or closing) at least one of the plurality of switches prior to provision of a second constant step current applied to the plurality of LED junctions to provide a substantially same load to each LED junction during the second constant step current.

It is understood that several processing steps and/or features of a device may be only briefly described, such steps and/or features being well known to those of ordinary skill in the art. Also, additional processing steps or features can be added, and certain of the following processing steps or features can be removed and/or changed while still implementing the claims. Thus, the above and following description should be understood to represent examples only, and are not intended to suggest that one or more steps or features is required. It should be noted that the operations of method 300 may be rearranged or otherwise modified within the scope of the various aspects. It is further noted that additional processes may be provided before, during, and after method 300 of FIG. 6, and that some other processes may only be briefly described herein. Thus, other implementations are possible with the scope of the various aspects described herein.

According to one aspect, the plurality of LED junctions in method 300 may be grouped in series or in LED junction modules coupled in parallel to one another, and each of the plurality of LED junction modules may include LED junctions coupled in series.

According to another aspect, method 300 may further include operating the plurality of switches in combination to configure a first half of the plurality of LED junction modules to be in series with a second half of the plurality of LED junction modules prior to provision of a constant step current.

According to yet another aspect, method 300 may further include operating the plurality of switches in combination to couple in series a fraction of the plurality of LED junction modules with one another prior to routing a constant step current.

According to yet another aspect, method 300 may further include operating the plurality of switches in combination to couple in series a half, a third, a fourth, a fifth, or a sixth of the plurality of LED junction modules with one another prior to routing a constant step current.

According to yet another aspect, method 300 may further include operating the plurality of switches in combination at each of a plurality of constant step currents applied to the plurality of LED junctions to provide a substantially same load to each LED junction during each of the plurality of constant step currents.

According to yet another aspect, method 300 may further include operating the plurality of switches in combination at each of a plurality of constant step currents applied to the plurality of LED junctions to activate each LED junction during each of the plurality of constant step currents.

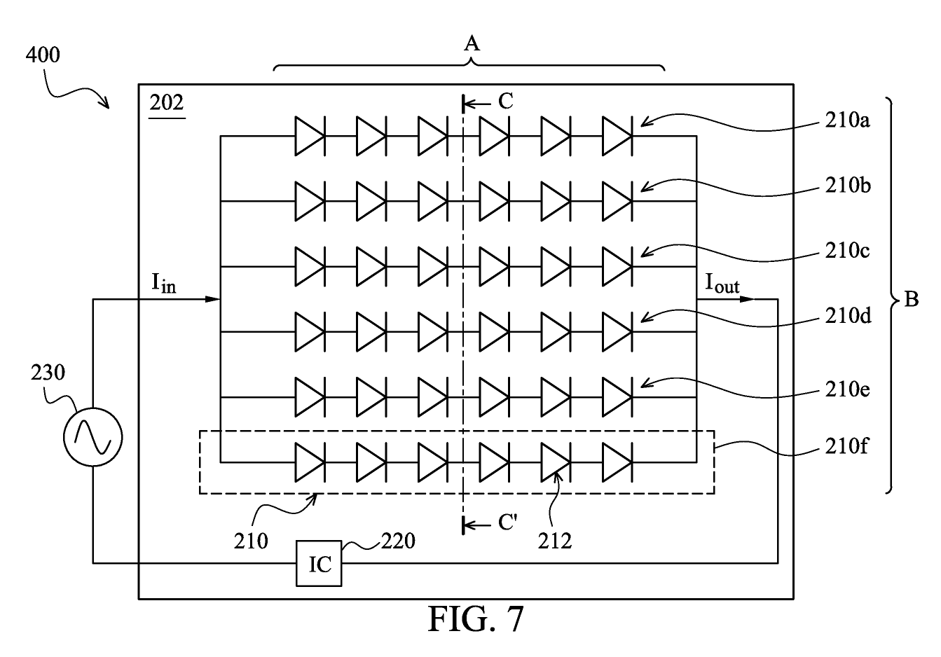

Referring now to FIG. 7, a UHV LED device 400 including a cross-sectional line C-C′ is illustrated in accordance with an embodiment of the present disclosure. In one embodiment, UHV LED device 400 includes a substrate 202, a passive component including a plurality of LED junctions 212 disposed above the substrate 202 and coupled to one another, and a control component including a plurality of switches (e.g., as illustrated and further described below with respect to FIGS. 9A-12) embedded within the substrate 202 and coupled to the plurality of LED junctions 212 to control routing of current (e.g., a plurality of constant step currents provided by a power source 230) applied across the plurality of LED junctions 212. Integrated circuit (IC) 220 may function to control the control component of device 400, and in one example may configure each of the plurality of switches (e.g., to open or close).

Similarly numbered features in devices 200, 200-1, 200-2, and 200-3 (such as substrate 202, LED junction modules 210, LED junctions 212, IC 220, and power source 230) and related descriptions are fully applicable in this embodiment with respect to device 400 although applicable descriptions may not be repeated here to avoid repetitive descriptions. In this embodiment, IC 220 is illustrated as being formed on or within substrate 202, although the present disclosure and IC 220 is not so limited. In one example, IC 220 may be disposed over the substrate 202, within the substrate 202, and/or on a separate printed circuit board (PCB) exterior to the substrate and emitter.

According to one aspect, the plurality of LED junctions 212 may be coupled in series with one another, and in one embodiment, the LED junctions may not be coupled in parallel.

According to another aspect, the plurality of LED junctions 212 may be grouped in LED junction modules 210 coupled in parallel to one another, and each of the plurality of LED junction modules 210 may include LED junctions 212 coupled in series.

In one embodiment, device 400 is shown including B LED junction modules 210 (e.g., modules 210a through 210z) coupled in parallel to one another, and each LED junction module 210 includes A LED junctions 212 coupled in series to one another. The total number of LED junctions is then A×B, and the B LED junction modules are coupled in parallel prior to routing of a first constant step current across the plurality of LED junctions. A and B are any whole numbers and thus device 200 is not limited to a particular number of LED junction modules 210 or a particular number of LED junctions 212 within each module 210.

According to yet another aspect, IC 220 may configure the plurality of switches of a control component such that a first half of the plurality of LED junction modules 210 are in series with a second half of the plurality of LED junction modules 210 prior to routing of a constant step current.

According to yet another aspect, IC 220 may configure the plurality of switches in combination to couple in series a fraction of the plurality of LED junction modules with one another prior to routing a constant step current.

According to yet another aspect, IC 220 may configure the plurality of switches in combination to couple in series a half, a third, a fourth, a fifth, or a sixth of the plurality of LED junction modules with one another prior to routing a constant step current.

According to yet another aspect, IC 220 may configure the plurality of switches in combination at each of a plurality of constant step currents applied to the plurality of LED junctions to provide a substantially same load to each LED junction during each of the plurality of constant step currents or to route a substantially same current to each LED junction during each of the plurality of constant step currents.

According to yet another aspect, IC 220 may configure the plurality of switches in combination at each of a plurality of constant step currents applied to the plurality of LED junctions to activate each LED junction during each of the plurality of constant step currents

According to yet another aspect, IC 220 may configure the plurality of switches to operate such that: sets of (C₁A) LED junctions 212 coupled in series are formed and sets of (B/C₂) LED junction modules coupled in series are coupled in parallel prior to routing a constant step current (B/C₁)i through each of the LED junctions 212, wherein A, B, C₁, and C₂ are whole numbers; C₁ and C₂ are each whole number factors of B (C₁×C₂=B) and not equal to B; and i is a current routed through each LED junction 212.

Thus, in one embodiment, IC 220 may dynamically configure or reconfigure a plurality of electrical connections (e.g., switches) coupled to the plurality of LED junctions 212 or the plurality of LED junction modules 210. In one aspect, the plurality of switches are configured in combination at each of a plurality of constant step currents applied across the plurality of LED junctions 212 or the plurality of LED junction modules 210 to provide a substantially same load to each LED junction 212 during each of the plurality of constant step currents or to activate each LED junction during each of the plurality of constant step currents (e.g., as shown in FIGS. 3A-1, 3B-1, 3C-1). In another aspect, the plurality of switches are configured such that a first half of the plurality of LED junction modules 210 (e.g., modules 210a, 210c, 210e of FIG. 3B-1) are in series with the other half or a second half of the plurality of LED junction modules 210 (e.g., modules 210b, 210d, 210f of FIG. 3B-1) prior to routing of a constant step current. In accordance with another aspect, the plurality of switches are configured such that a fraction of the plurality of LED junction modules (e.g., modules 210a, 210b, 210c or modules 210d, 210e, 210f of FIG. 3C-1) are in series with one another prior to routing of a constant step current. In accordance with another aspect, each of the plurality of LED junctions 212 is active during each of the plurality of constant step currents.

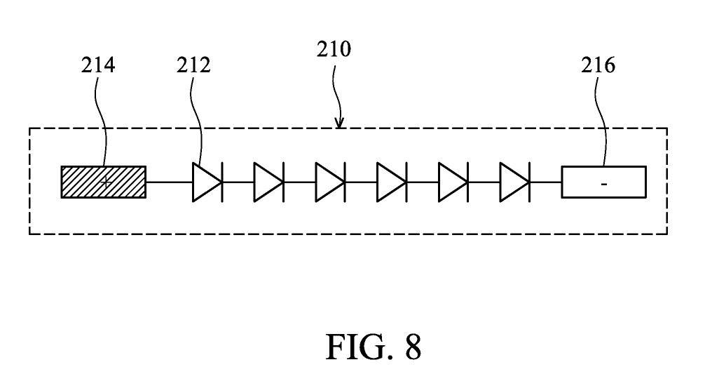

Referring now to FIGS. 8 and 9A-9B, FIG. 8 illustrates a top view of an embodiment of LED junction module 210 in accordance with an embodiment of the present disclosure, and FIGS. 9A and 9B illustrate different embodiments of cross-sectional views of the device 400 of FIG. 7 along line C-C′ for the case of B=6 LED junction modules 210 in accordance with embodiments of the present disclosure.

In one embodiment, each LED junction module 210 includes a plurality of LED junctions 212 coupled together in series and an anode 214 and a cathode 216 through which current is applied to the LED junction module 210.

FIG. 9A illustrates a device 400-1 including a passive component 201 having 6 LED junction modules 210 disposed above the substrate 202 and coupled to one another, and a control component 301 including a plurality of anode electrodes 314 and cathode electrodes 316 coupled to respective anodes 214 and cathodes 216 of corresponding LED junction modules 210. Elements of control component 301 may be embedded within substrate 202. Thus, in one embodiment, device 400 includes passive component 201 having LED junction modules 210a-210f disposed above substrate 202, and control component 301 having anode electrodes 314a-314f and cathode electrodes 316a-316f coupled to anodes 214a-214f and cathodes 216a-216f of LED junction modules 210a-210f, respectively. Anode electrodes 314a-314f and cathode electrodes 316a-316f are embedded within substrate 202 in one embodiment.

Device 400-2 of FIG. 9B is substantially similar to device 400-1 of FIG. 9A, and similarly numbered features in device 400 and 400-1 (such as substrate 202, LED junction modules 210, anodes 214, cathodes 216, anode electrodes 314, and cathode electrodes 316) and related descriptions are fully applicable in this embodiment with respect to device 400-2 although applicable descriptions may not be repeated here to avoid repetitive descriptions. In this embodiment, passive component 201 includes a sapphire layer 218 disposed above the plurality of LED junctions of LED junction modules 210. Sapphire layer 218 allows for fabricating all LED junction modules 210 as one block to be bonded to substrate 202, but sapphire layer 218 is an optional element. Without the sapphire layer 218, the LED junction modules 210 may be fabricated separately and bonded to substrate 202 after binning (or grouping).

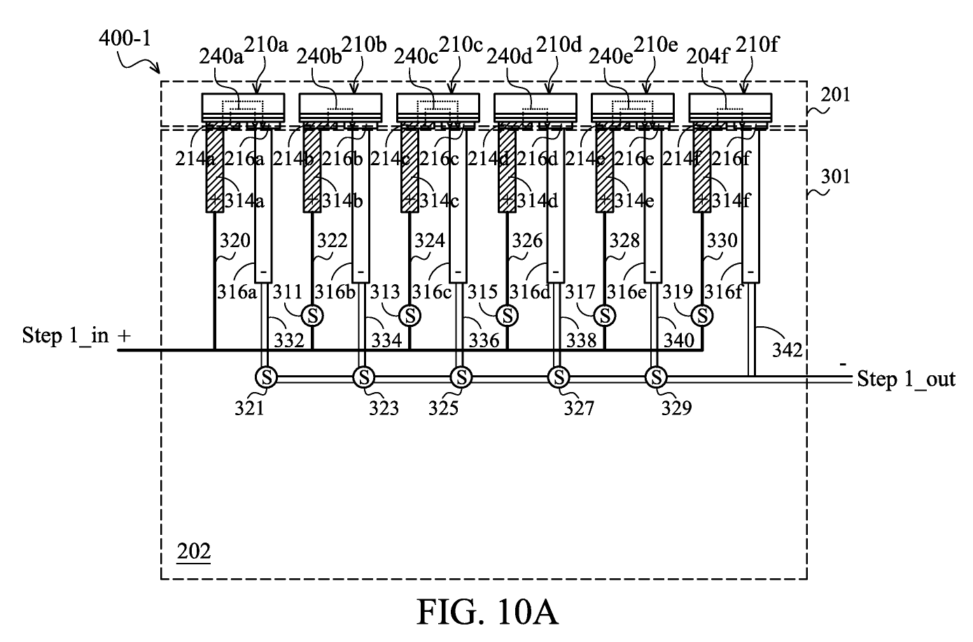

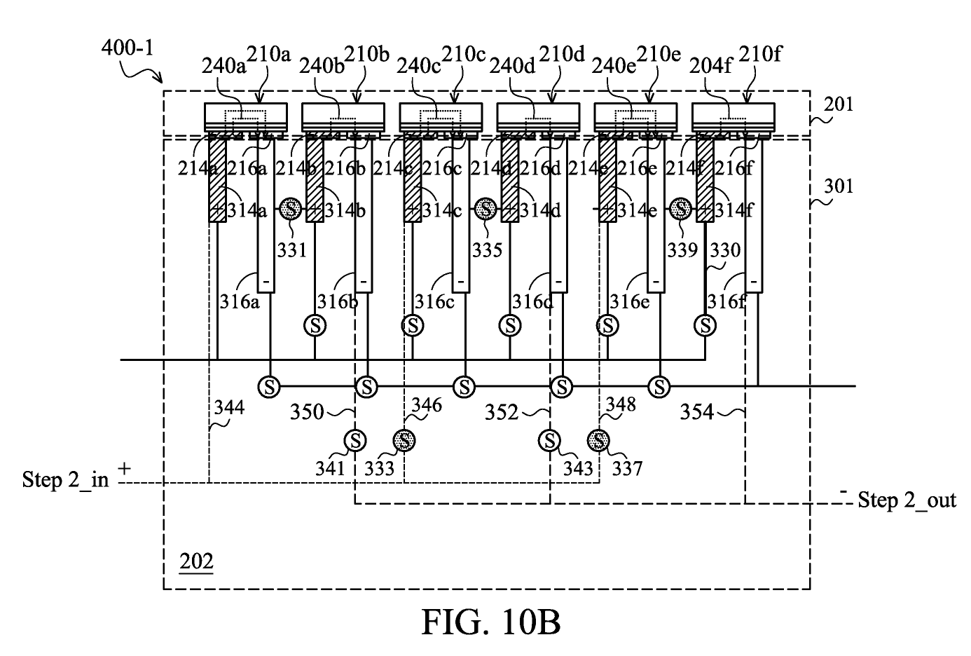

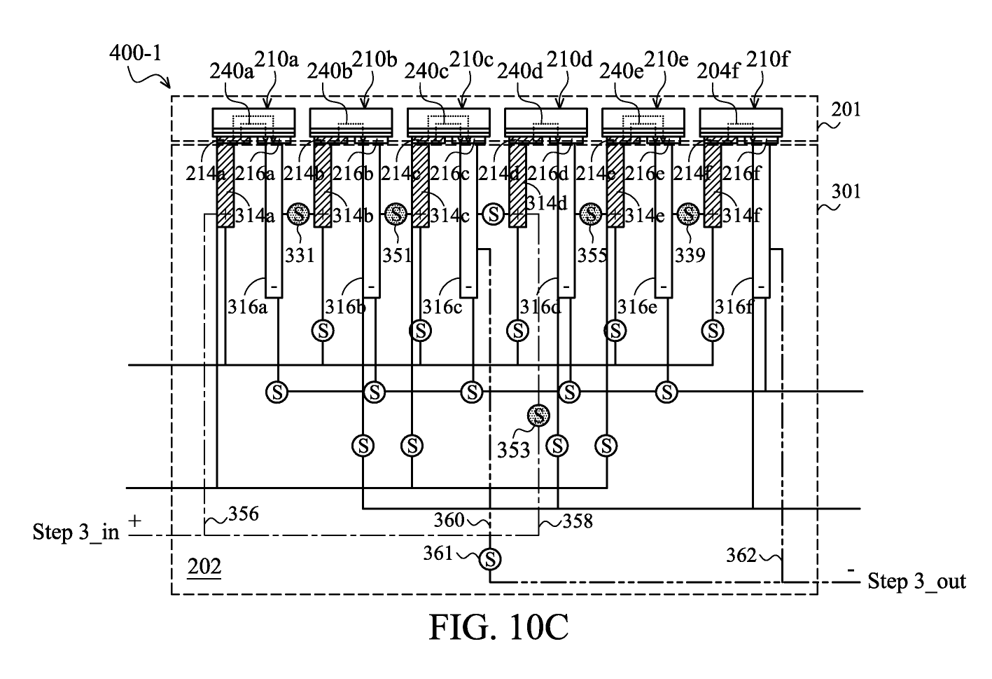

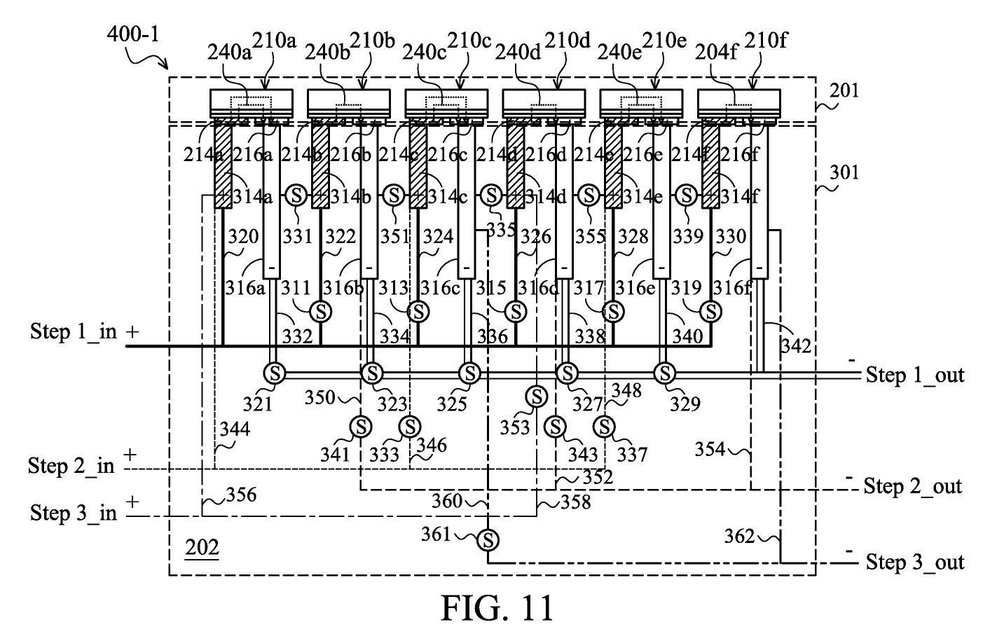

Referring now to FIGS. 10A-10C, and 11, more detailed cross-sectional views are illustrated of control component 301 of device 400-1 including a plurality of switches representing just one example of a coupling scheme for six LED junction modules 210 in accordance with embodiments of the present disclosure. Other coupling schemes including different configurations of switches are within the scope of the present disclosure; e.g., for different numbers of LED junctions or LED junction modules. FIGS. 10A-10C and 11 illustrate device 400-1 including control component 301 having a plurality of switches embedded within the substrate 202 and operably coupled to the plurality of LED junction modules 210 (and/or LED junctions 212). The plurality of switches may be configured (e.g., opened or closed), for example via IC 220, to route a plurality of step currents applied across the plurality of LED junction modules 210 (and/or LED junctions 212). FIGS. 10A-10C separately highlight the active switches and lines for each step current, and FIG. 11 illustrates the switches and lines fully referenced. The plurality of switches may include various applicable switches, including but not limited to two-way switches and three-way switches.

FIG. 10A illustrates a step 1 current flow through device 400 and in particular through LED junction modules 210a-210f which are first coupled in parallel. Line 320 and closed switches 311, 313, 315, 317, 319 pass step 1 input current to modules 210a, 210b, 210c, 210d, 210e, 210f, respectively, and closed switches 321, 323, 325, 327, 329 and line 342 pass a step 1 output current from modules 210a, 210b, 210c, 210d, 210e, 210f, respectively.

Step 1 current passes through line 320, anode electrode 314a, anode 214a, line 240a, and cathode 216a of module 210a, cathode electrode 316a, line 332, and switch 321. Step 1 current further passes through switch 311, line 322, anode electrode 314b, anode 214b, line 240b, and cathode 216b of module 210b, cathode electrode 316b, line 334, and switch 323. Step 1 current further passes through switch 313, line 324, anode electrode 314c, anode 214c, line 240c, and cathode 216c of module 210c, cathode electrode 316c, line 336, and switch 325. Step 1 current further passes through switch 315, line 326, anode electrode 314d, anode 214d, line 240d, and cathode 216d of module 210d, cathode electrode 316d, line 338, and switch 327. Step 1 current further passes through switch 317, line 328, anode electrode 314e, anode 214e, line 240e, and cathode 216e of module 210e, cathode electrode 316e, line 340, and switch 329. Step 1 current further passes through switch 319, line 330, anode electrode 314f, anode 214f, line 240f, and cathode 216f of module 210f, cathode electrode 316f, and line 342. Thus, the plurality of switches are configured to route step 1 current through device 400-1 as shown for example in FIG. 3A-1, in which 6 LED junction modules 210a-210f are coupled in parallel and each module 210 receives and passes a current i.

FIG. 10B illustrates a step 2 current flow through device 400 and in particular through LED junction modules 210a-210f. Switches 311, 313, 315, 317, 319, and switches 321, 323, 325, 327, 329 (FIGS. 8A and 9) are opened so current does not flow through them. These switches are not labeled with reference numbers in FIG. 10B for clarity but they are labeled in FIG. 11. FIG. 10B illustrates lines 344, 346, 348 and closed switches 331, 333, 335, 337, 339 pass step 2 input current to modules 210a-210f, and closed switches 341, 343 and lines 350, 352, and 354 pass a step 2 output current from modules 210a-210f.

Step 2 current passes through line 344, anode electrode 314a, anode 214a, line 240a, and cathode 216a of module 210a, cathode electrode 316a, switch 331, anode electrode 314b, anode 214b, line 240b, and cathode 216b of module 210b, cathode electrode 316b, line 350, and switch 341. Step 2 current further passes through switch 333, line 346, anode electrode 314c, anode 214c, line 240c, and cathode 216c of module 210c, cathode electrode 316c, switch 335, anode electrode 314d, anode 214d, line 240d, and cathode 216d of module 210d, cathode electrode 316d, line 352, and switch 343. Step 2 current further passes through closed switch 337, line 348, anode electrode 314e, anode 214e, line 240e, and cathode 216e of module 210e, cathode electrode 316e, closed switch 339, anode electrode 314f, anode 214f, line 240f, and cathode 216f of module 210f, cathode electrode 316f, and line 354. Thus, the plurality of switches are configured to route step 2 current through device 400-1 as shown for example in FIG. 3B-1, in which 3 LED junction modules 211a-211c are coupled in parallel and each module 211a, 211b, or 211c receives and passes a current i.

FIG. 10C illustrates a step 3 current flow through device 400 and in particular through LED junction modules 210a-210f. Switches 311, 313, 315, 317, 319 and switches 321, 323, 325, 327, 329 (FIGS. 10A and 11), and switches 333, 335, 337 and switches 341, 343 (FIGS. 10B and 11) are opened so current does not flow through them. These switches are not labeled in FIG. 10C for clarity but are labeled in FIG. 11. FIG. 10C shows lines 356, 358 and closed switches 331, 351, 353, 355, and 339 pass step 3 input current to modules 210a-210f, and closed switch 361 and line 362 pass a step 3 output current from modules 210a-210f.

Step 3 current passes through line 356, anode electrode 314a, anode 214a, line 240a, and cathode 216a of module 210a, cathode electrode 316a, switch 331, anode electrode 314b, anode 214b, line 240b, and cathode 216b of module 210b, cathode electrode 316b, switch 351, anode electrode 314c, anode 214c, line 240c, and cathode 216c of module 210c, cathode electrode 316c, line 360, and switch 361. Step 3 current further passes through line 358, switch 353, anode electrode 314d, anode 214d, line 240d, and cathode 216d of module 210d, cathode electrode 316d, switch 355, anode electrode 314e, anode 214e, line 240e, and cathode 216e of module 210e, cathode electrode 316e, switch 339, anode electrode 314f, anode 214f, line 240f, and cathode 216f of module 210f, cathode electrode 316f, and line 362. Thus, the plurality of switches are configured to route step 3 current through device 400-1 as shown for example in FIG. 3C-1, in which 2 LED junction modules 213a and 213b are coupled in parallel and each module 213a, 213b receives and passes a current i.

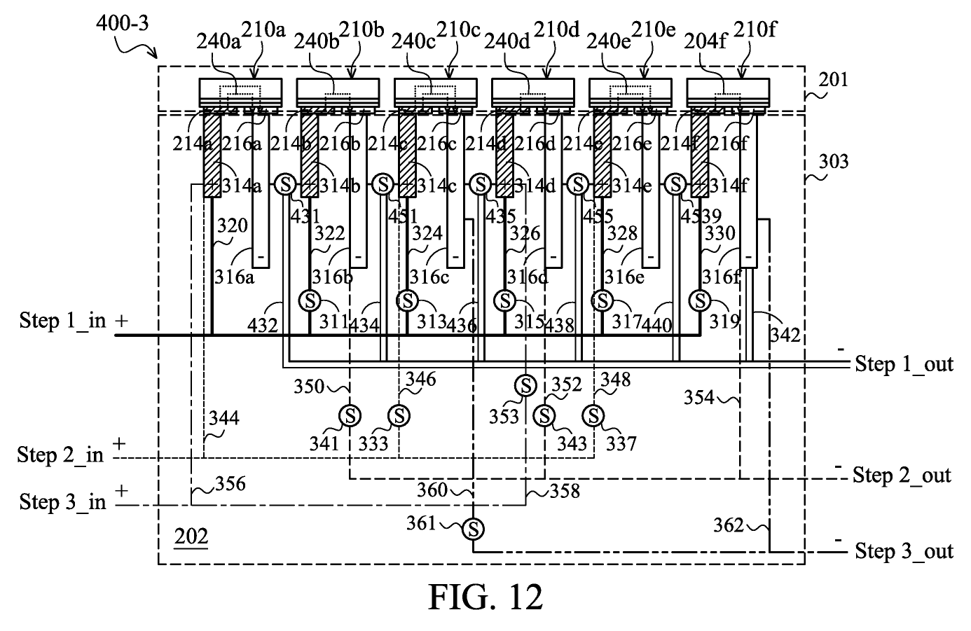

FIG. 11 illustrates the lines and switches in control component 301 including all the switch and line reference numbers as described above with respect to FIGS. 10A-10C, in which the active switches and lines for each step current are separately highlighted. In this embodiment, the switches are two-way switches but the present disclosure is not limited to such switches, and in one example, three-way switches may also be used in combination with two-way switches as further described below in combination with FIG. 12.

FIG. 12 illustrates the lines and switches in a control component 303 of a UHV LED device 400-3 which is substantially similar to the control component 301 of UHV LED device 400-1. Similarly or the same numbered features in device 400-1 and related descriptions are fully applicable in this embodiment with respect to device 400-3 although applicable descriptions may not be repeated here to avoid repetitive descriptions. In this embodiment, some of the embedded switches are removed and some of the embedded switches are replaced with three-way switches. In this embodiment, two-way switches 321, 323, 325, 327, 329 and two-way switches 331, 351, 335, 355, and 339 are removed and replaced by three-way switches 431, 451, 435, 455, and 439. Lines 332, 334, 336, 338, and 340 are removed and replaced by lines 432, 434, 436, 438, and 440, which each function as a line out routing a step 1 current out of device 400-3. As illustrated, three-way switches 431, 451, 435, 455, and 439 are each coupled between a respective cathode electrode (e.g., cathode electrodes 316a, 316b, 316c, 316d, 316e), a respective anode electrode (e.g., anode electrodes 314b, 314c, 314d, 314e, 314f), and a line out (e.g., lines 432, 434, 436, 438, 440). Step 1, step 2, and step 3 currents are routed in substantially the same way as described above with respect to FIGS. 10A-10C, but the three-way switches 431, 451, 435, 455, and 439 function to either pass step 1 current to a line out or to pass either step 2 or step 3 current to an anode electrode of an adjacent LED junction module. Use of the three-way switches simplifies the architecture of the control component in accordance with one aspect of the present disclosure.

Thus, according to one aspect, the plurality of switches of a control component may be configured such that a first half of the plurality of LED junction modules 210 are in series with a second half of the plurality of LED junction modules 210 prior to provision of a constant step current.

According to another aspect, the plurality of switches of a control component may be configured such that a half of the plurality of LED junction modules are in series with one another prior to provision of a constant step current.

According to yet another aspect, the plurality of switches may be configured at each of the plurality of constant step currents applied to the plurality of LED junctions to provide a substantially same load to each LED junction or to route a substantially same current to each LED junction during each of the plurality of constant step currents.

According to yet another aspect, the plurality of switches may be configured such that: sets of (C₁A) LED junctions 212 coupled in series are formed and sets of (B/C₂) LED junction modules coupled in series are coupled in parallel prior to routing a constant step current (B/C₁)i through each of the LED junctions 212, wherein A, B, C₁, and C₂ are whole numbers; C₁ and C₂ are each whole number factors of B (C₁×C₂=B) and not equal to B; and i is a current routed through each LED junction 212.

Thus, in one embodiment, the plurality of switches may be dynamically configured at each of a plurality of constant step currents received by the plurality of LED junction modules 210 to provide a substantially same load to each LED junction 212 during each of the plurality of constant step currents (e.g., as shown in FIGS. 10A-10C) and/or to activate each of the plurality of LED junctions 212 during each of the plurality of constant step currents.

Advantageously, the present disclosure provides for efficiently packaging a UHV emitter's passive component and control component.

Thus, the present disclosure provides for various embodiments. According to one embodiment, a method of controlling an ultra high voltage (UHV) light emitting diode (LED) device is provided. The method includes routing a first constant step current through a plurality of LED junction modules disposed over a substrate, each of the plurality of LED junction modules coupled in parallel to one another, and each of the plurality of LED junction modules including a plurality of LED junctions coupled in series. The method further includes reconfiguring a coupling scheme of the plurality of LED junction modules, and routing a second constant step current through the plurality of LED junction modules to provide a substantially same load to each LED junction.

In another embodiment, a method of controlling a UHV LED device includes providing B LED junction modules over a substrate, each of the B LED junction modules coupled in parallel to one another, and each of the B LED junction modules including A LED junctions coupled in series. The method further includes routing a first constant step current Bi through the B LED junction modules, and forming sets of (C₁A) LED junctions coupled in series and coupling in parallel sets of (B/C₂) LED junction modules coupled in series prior to routing a subsequent constant step current (B/C₁)i through each of the LED junctions. A, B, C₁, and C₂ are whole numbers; C₁ and C₂ are each whole number factors of B (C₁×C₂=B) and not equal to B; and i is a current routed through each LED junction.

In yet another embodiment, a method of controlling a UHV LED device includes providing a plurality of LED junction modules over a substrate, each of the plurality of LED junction modules coupled in parallel to one another, and each of the plurality of LED junction modules including a plurality of LED junctions coupled in series. The method further includes routing a first constant step current through the plurality of LED junction modules lighting each of the plurality of LED junction modules, reconfiguring a coupling scheme of the plurality of LED junction modules, and routing a second constant step current through the plurality of LED junction modules lighting each of the plurality of LED junction modules and providing a substantially same load to each LED junction with the first and second constant step currents.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. A method of controlling an ultra high voltage (UHV) light emitting diode (LED) device, the method comprising:
routing a first constant step current through a plurality of LED junction modules disposed over a substrate, each of the plurality of LED junction modules coupled in parallel to one another, and each of the plurality of LED junction modules including a plurality of LED junctions coupled in series;
reconfiguring a coupling scheme of the plurality of LED junction modules; and
routing a second constant step current through the plurality of LED junction modules, wherein a substantially same load is provided to each LED junction.

2. The method of claim 1, wherein reconfiguring the coupling scheme of the plurality of LED junction modules includes coupling in series a first half of the plurality of LED junction modules with a second half of the plurality of LED junction modules prior to routing a constant step current.

3. The method of claim 1, wherein reconfiguring the coupling scheme of the plurality of LED junction modules includes coupling in series a fraction of the plurality of LED junction modules with one another prior to routing a constant step current.

4. The method of claim 3, wherein reconfiguring the coupling scheme of the plurality of LED junction modules includes coupling in series a half, a third, a fourth, a fifth, or a sixth of the plurality of LED junction modules with one another prior to routing a constant step current.

5. The method of claim 1, wherein the plurality of LED junction modules includes B LED junction modules coupled in parallel and each LED junction module includes A LED junctions coupled in series, the method further comprising:
forming sets of (C₁A) LED junctions coupled in series; and
coupling in parallel sets of (B/C₂) LED junction modules coupled in series prior to routing a subsequent constant step current (B/C₁)i through the plurality of LED junction modules,
wherein A, B, C₁, and C₂ are whole numbers,
wherein C₁ and C₂ are each whole number factors of B (C₁×C₂=B) and not equal to B, and
wherein i is a current routed through each LED junction.

6. The method of claim 1, wherein the plurality of LED junction modules includes B LED junction modules coupled in parallel and each LED junction module includes A LED junctions coupled in series, the method further comprising:
routing a first constant step current Bi through the plurality of LED junction modules;
forming sets of 2A LED junctions coupled in series and coupling in parallel sets of (B/3) LED junction modules coupled in series prior to routing a second constant step current (B/2)i through the plurality of LED junction modules; and
forming sets of 3A LED junctions coupled in series and coupling in parallel sets of (B/2) LED junction modules coupled in series prior to routing a third constant step current (B/3)i through the plurality of LED junction modules,
wherein A and B are whole numbers, and i is a current routed through each LED junction.

7. The method of claim 1, wherein the plurality of LED junction modules includes B LED junction modules coupled in parallel and each LED junction module includes A LED junctions coupled in series, the method further comprising:
routing a first constant step current Bi through the plurality of LED junction modules;
forming sets of 2A LED junctions coupled in series and coupling in parallel sets of (B/6) LED junction modules coupled in series prior to routing a second constant step current (B/2)i through the plurality of LED junction modules;
forming sets of 3A LED junctions coupled in series and coupling in parallel sets of (B/4) LED junction modules coupled in series prior to routing a third constant step current (B/3)i through the plurality of LED junction modules;
forming sets of 4A LED junctions coupled in series and coupling in parallel sets of (B/3) LED junction modules coupled in series prior to routing a fourth constant step current (B/4)i through the plurality of LED junction modules; and
forming sets of 6A LED junctions coupled in series and coupling in parallel sets of (B/2) LED junction modules coupled in series prior to routing a fifth constant step current (B/6)i through the plurality of LED junction modules,
wherein A and B are whole numbers, and i is a current routed through each LED junction.

8. The method of claim 1, wherein the plurality of LED junction modules includes B LED junction modules coupled in parallel and each LED junction module includes A LED junctions coupled in series, the method further comprising:
routing a first constant step current Bi through the plurality of LED junction modules;
forming sets of 3A LED junctions coupled in series and coupling in parallel sets of (B/3) LED junction modules coupled in series prior to routing a second constant step current (B/3)i through the plurality of LED junction modules,
wherein A and B are whole numbers, and i is a current routed through each LED junction.

9. The method of claim 1, further comprising activating each of the plurality of LED junctions with each constant step current.

10. A method of controlling an ultra high voltage (UHV) light emitting diode (LED) device, the method comprising:
providing B LED junction modules over a substrate, each of the B LED junction modules coupled in parallel to one another, and each of the B LED junction modules including A LED junctions coupled in series;
routing a first constant step current Bi through the B LED junction modules; and
forming sets of (C₁A) LED junctions coupled in series and coupling in parallel sets of (B/C₂) LED junction modules coupled in series prior to routing a subsequent constant step current (B/C₁)i through each of the LED junctions,
wherein A, B, C₁, and C₂ are whole numbers,
wherein C₁ and C₂ are each whole number factors of B (C₁×C₂=B) and not equal to B, and
wherein i is a current routed through each LED junction.

11. The method of claim 10, further comprising coupling in series a first half of a plurality of LED junction modules with a second half of the plurality of LED junction modules prior to routing a constant step current.

12. The method of claim 10, further comprising coupling in series a fraction of a plurality of LED junction modules with one another prior to routing a constant step current.

13. The method of claim 10, further comprising:
forming sets of 2A LED junctions coupled in series and coupling in parallel sets of (B/3) LED junction modules coupled in series prior to routing a second constant step current (B/2)i through the plurality of LED junction modules; and
forming sets of 3A LED junctions coupled in series and coupling in parallel sets of (B/2) LED junction modules coupled in series prior to routing a third constant step current (B/3)i through the plurality of LED junction modules.

14. The method of claim 10, further comprising:
forming sets of 2A LED junctions coupled in series and coupling in parallel sets of (B/6) LED junction modules coupled in series prior to routing a second constant step current (B/2)i through the plurality of LED junction modules;
forming sets of 3A LED junctions coupled in series and coupling in parallel sets of (B/4) LED junction modules coupled in series prior to routing a third constant step current (B/3)i through the plurality of LED junction modules;
forming sets of 4A LED junctions coupled in series and coupling in parallel sets of (B/3) LED junction modules coupled in series prior to routing a fourth constant step current (B/4)i through the plurality of LED junction modules; and
forming sets of 6A LED junctions coupled in series and coupling in parallel sets of (B/2) LED junction modules coupled in series prior to routing a fifth constant step current (B/6)i through the plurality of LED junction modules.

15. The method of claim 10, further comprising:
forming sets of 3A LED junctions coupled in series and coupling in parallel sets of (B/3) LED junction modules coupled in series prior to routing a second constant step current (B/3)i through the plurality of LED junction modules.

16. The method of claim 10, further comprising activating each of the plurality of LED junctions during each constant step current.

17. A method of controlling an ultra high voltage (UHV) light emitting diode (LED) device, the method comprising:
providing a plurality of LED junction modules over a substrate, each of the plurality of LED junction modules coupled in parallel to one another, and each of the plurality of LED junction modules including a plurality of LED junctions coupled in series;
routing a first constant step current through the plurality of LED junction modules lighting each of the plurality of LED junction modules;
reconfiguring a coupling scheme of the plurality of LED junction modules; and
routing a second constant step current through the plurality of LED junction modules lighting each of the plurality of LED junction modules and providing a substantially same load to each LED junction with the first and second constant step currents.

18. The method of claim 17, wherein reconfiguring the coupling scheme of the plurality of LED junction modules includes coupling in series a first half of the plurality of LED junction modules with a second half of the plurality of LED junction modules prior to routing a constant step current.

19. The method of claim 17, wherein reconfiguring the coupling scheme of the plurality of LED junction modules includes coupling in series a fraction of the plurality of LED junction modules with one another prior to routing a constant step current.

20. The method of claim 19, wherein reconfiguring the coupling scheme of the plurality of LED junction modules includes coupling in series a half, a third, a fourth, a fifth, or a sixth of the plurality of LED junction modules with one another prior to routing a constant step current.
